(19) United States
(12) Patent Application Publication
(10) Pub. No.: US 2024/0359932 A1
(43) Pub. Date: Oct. 31, 2024

(54) IMAGE FORMING APPARATUS FORMING IMAGE ON RECORDING MEDIUM

(71) Applicant: KYOCERA Document Solutions Inc., Osaka (JP)

(72) Inventor: Satoru NAKAMURA, Osaka (JP)

(73) Assignee: KYOCERA Document Solutions Inc., Osaka (JP)

(21) Appl. No.: 18/638,821

(22) Filed: Apr. 18, 2024

(30) Foreign Application Priority Data
Apr. 28, 2023 (JP) 2023-074254

(51) Int. Cl. B65H 5/22; B41J 2/165; B41J 2/17; B41J 13/08

(52) U.S. Cl. CPC B65H 5/224; B41J 2/16526; B41J 2/1721; B41J 13/08; B65H 2404/25

(57) ABSTRACT

An image forming apparatus includes a recording head including a plurality of nozzles that each eject a liquid droplet to a recording medium, the nozzles being arranged in an array, a transport device including an endless belt that transports the recording medium toward an image forming position where the recording head forms an image, a plurality of through holes formed in the endless belt, to be used for a flushing operation, a liquid droplet receptacle that receives a flushing liquid droplet, which has been ejected from the nozzle and passed through the through hole, without being involved in image forming, a skew detection device that detects whether the endless belt is running straightly or skewing so as to shift in a belt width direction, and a levelness adjustment device that adjusts levelness of the transport device.

### INCORPORATION BY REFERENCE

This application claims priority to Japanese Patent Application No. 2023-074254 filed on Apr. 28, 2023, the entire contents of which are incorporated by reference herein.

### BACKGROUND

The present disclosure relates to an image forming apparatus that forms an image on a recording medium.

Some of existing image forming apparatuses include a liquid ejecting head having an array of a plurality of nozzles that each eject ink onto a recording medium, a transport belt that transports the recording medium toward an image forming position where the liquid ejecting head forms an image, a spitting receptacle that receives the ink spitted from the nozzle in a flushing operation, and a belt position detector that detects a position of the transport belt in a belt width direction.

The transport belt incudes a plurality of suction holes formed so as to penetrate therethrough, from the front face to the back face. In the flushing operation, the ink droplet spitted from the nozzle passes through the suction hole of the transport belt, and falls onto the spitting receptacle.

When the belt position detector detects that the position of the transport belt is shifted in the belt width direction from the normal position, it should be assumed that the transport belt is not running straightly, but skewing so as to shift in the belt width direction.

### SUMMARY

The disclosure proposes further improvement of the foregoing techniques.

In an aspect, the disclosure provides an image forming apparatus including a recording head, a transport device, a plurality of through holes, a liquid droplet receptacle, a skew detection device, and a levelness adjustment device. The recording head includes a plurality of nozzles that each eject a liquid droplet to a recording medium, the nozzles being arranged in an array. The transport device includes an endless belt that transports the recording medium toward an image forming position where the recording head forms an image. The plurality of through holes are formed in the endless belt, to be used for a flushing operation. The liquid droplet receptacle receives a flushing liquid droplet, which has been ejected from the nozzle and passed through the through hole, without being involved in image forming. The skew detection device detects whether the endless belt is running straightly or skewing so as to shift in a belt width direction. The levelness adjustment device adjusts levelness of the transport device.

### BRIEF DESCRIPTION OF THE DRAWINGS

FIG. 1 is a schematic cross-sectional view showing a configuration of an image forming apparatus according to Embodiment 1;

FIG. 2 is a plan view showing a transport device of the image forming apparatus according to Embodiment 1;

FIG. 3 is a perspective view showing the transport device of the image forming apparatus according to Embodiment 1;

FIG. 4 is a perspective view showing the transport device of the image forming apparatus according to Embodiment 1, with a transport belt removed and a support plate exposed;

FIG. 5 is a perspective view showing a head unit of the image forming apparatus according to Embodiment 1;

FIG. 6 is an enlarged schematic cross-sectional view showing a part of the image forming apparatus according to Embodiment 1;

FIG. 7 is a plan view showing a transport belt of the image forming apparatus according to Embodiment 1;

FIG. 8 is a partially enlarged plan view showing the transport belt of the image forming apparatus according to Embodiment 1;

FIG. 9 is a plan view of the transport belt of the image forming apparatus according to Embodiment 1, showing a straightly running state and a skewing state;

FIG. 10 is a schematic drawing showing a structure to support the transport device of the image forming apparatus;

FIG. 11 is a cross-sectional view taken along a line A-A in FIG. 10;

FIG. 12 is a schematic drawing showing a levelness adjustment device of the image forming apparatus according to Embodiment 1;

FIG. 13 is a cross-sectional view taken along a line A-A in FIG. 12;

FIG. 14 is a cross-sectional view taken along a line B-B in FIG. 12;

FIG. 15 is a cross-sectional view taken along a line C-C in FIG. 12;

FIG. 16 is a plan view showing a positional relation between through holes of the transport belt and nozzles of the image forming apparatus according to Embodiment 1, in a state where the transport belt is running straightly;

FIG. 17 is a plan view showing a positional relation between through holes of the transport belt and nozzles of the image forming apparatus according to Embodiment 1, in a state where the transport belt is skewing so as to shift to one side; and

FIG. 18 is a plan view showing a positional relation between through holes of the transport belt and nozzles of the image forming apparatus according to Embodiment 1, in a state where the transport belt is skewing so as to shift to the other side.

### DETAILED DESCRIPTION

Hereafter, an image forming apparatus according to an embodiment of the disclosure will be described, with reference to the drawings. In the drawings, the same or corresponding elements are given the same numeral, and the description of such elements will not be repeated.

### Embodiment 1

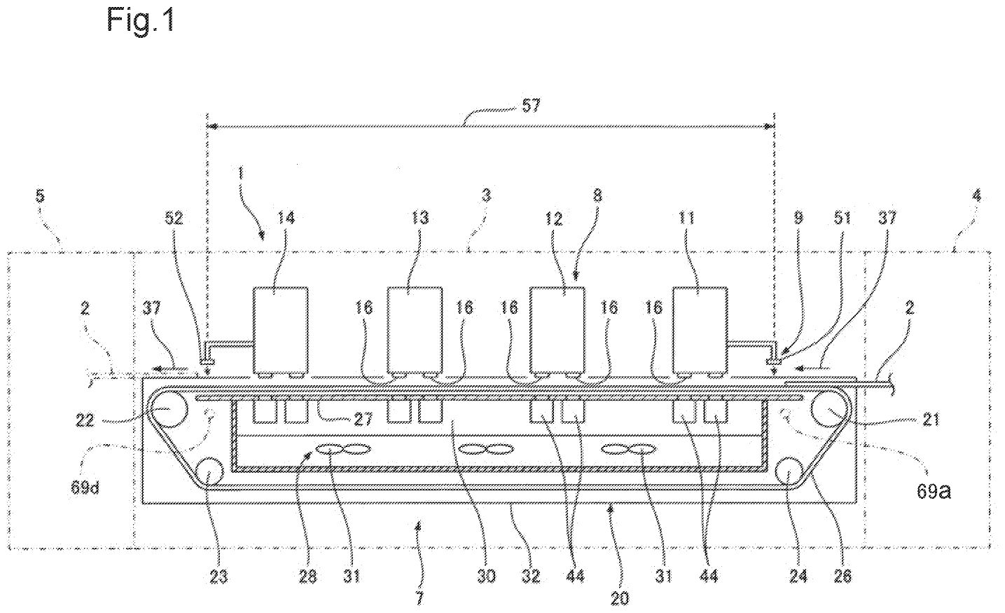

Referring to FIG. 1, the image forming apparatus 1 according to Embodiment 1 will be described. FIG. 1 is a schematic cross-sectional view showing a configuration of the image forming apparatus 1 according to Embodiment 1.

The image forming apparatus 1, configured to form an image, is for example a color multifunction peripheral, capable of executing a plurality of jobs such as copying, printing, scanning, and facsimile transmission. The image forming apparatus 1 includes a printing device 3 that records an image on a sheet 2 (exemplifying the recording medium in the disclosure), for example by ink jet printing, a sheet feeding device 4 that supplies the sheet 2 to the printing device 3, and a drying device 5 that dries the sheet 2 having the image recorded thereon.

The sheet 2 supplied to the printing device 3 from the sheet feeding device 4 undergoes the image forming operation executed by the printing device 3, is transported therefrom to the drying device 5 to be dried, and then discharged.

The printing device 3 of the image forming apparatus 1 includes a transport device 7 that transports the sheet 2, a recording device 8 that ejects ink onto the sheet 2 being transported, a skew detection device 9, and a levelness adjustment device 10.

The recording device 8 includes a plurality of head units 11 to 14. The head units 11 to 14 each include a plurality of recording heads 16.

The transport device 7 includes a frame body 20, a plurality of rollers 21 to 24 rotatably attached to the frame body 20, an endless transport belt 26 (exemplifying the endless belt in the disclosure) stretched over the rollers 21 to 24, a support plate 27 (also called platen) that supports the transport belt 26 from below, and a suction device 28 that adsorbs the sheet 2 delivered to the transport belt 26, to the surface thereof.

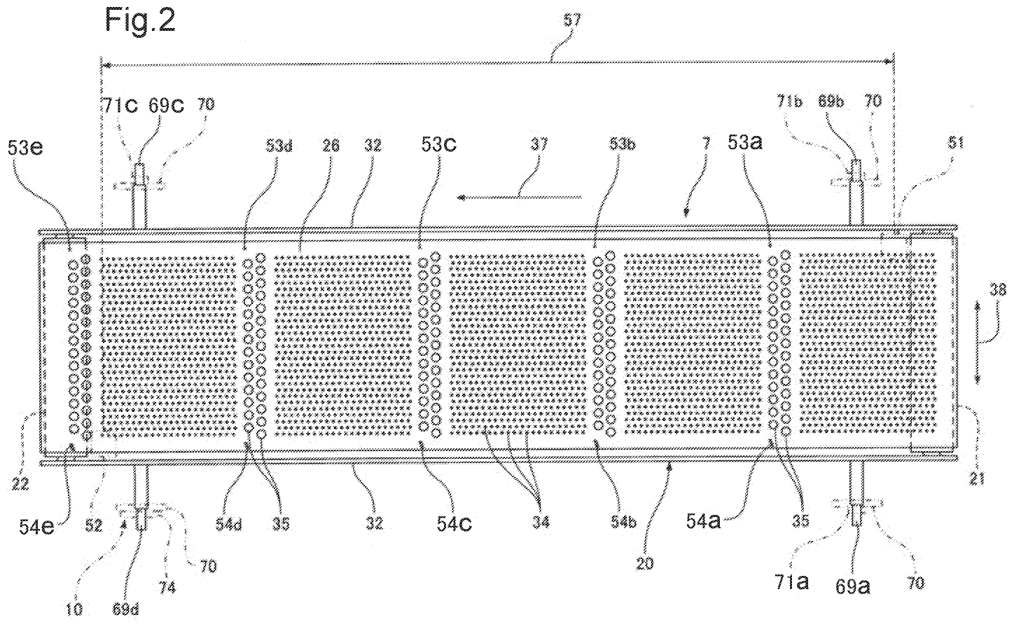

As shown in FIG. 2, a fixing frame 70 is provided at an outer position on each side of the transport device 7.

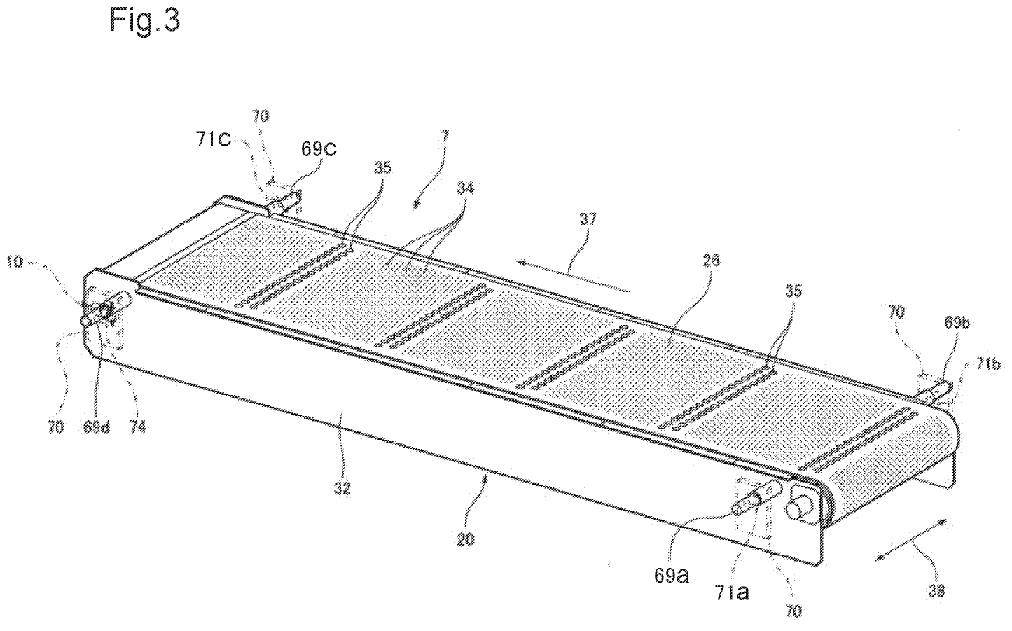

Referring to FIG. 1 to FIG. 3, a direction orthogonal to a moving direction 37 of the transport belt 26 will hereinafter be defined as belt width direction 38.

The frame body 20 includes a pair of side frames 32, opposed to each other in the belt width direction 38. The rollers 21 to 24 are supported between the pair of side frames 32.

One of the rollers 21 to 24 is driven so as to rotate, for example by a motor, so that the so as to rotate transport belt 26 revolves in one direction, and the remaining rollers are made to rotate. The transport belt 26 transports the sheet 2, toward an image forming position where the recording head 16 forms an image. The transport belt 26 is painted black, to absorb light.

The suction device 28 includes a suction chamber 30 formed under the support plate 27, and a plurality of suction fans 31 provided inside the suction chamber 30. The support plate 27 constitute a ceiling portion of the suction chamber 30.

The transport belt 26 includes a multitude of suction holes 34 and a plurality of through holes 35 for a flushing operation, formed so as to penetrate through the transport belt 26, from the front to back faces thereof. The through holes 35 are larger in diameter than the suction holes 34.

A plurality of sets of the through holes 35 are formed, each set being composed of two rows, along the moving direction 37 of the transport belt 26.

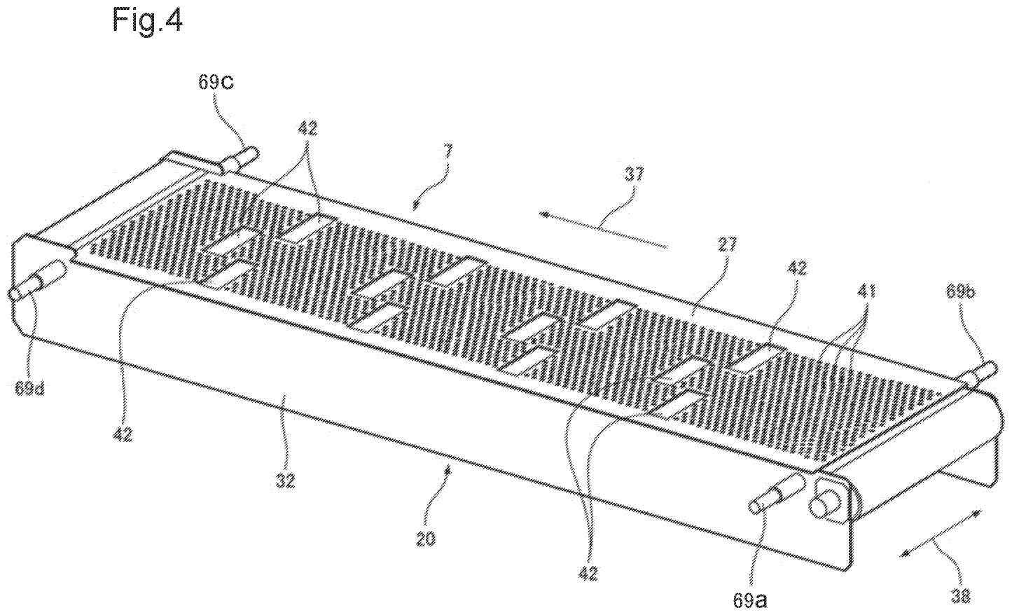

As shown in FIG. 4, the support plate 27 includes a multitude of intake holes 41, and a plurality of communication holes 42 for the flushing operation, formed so as to penetrate through the support plate 27 from the front to back faces thereof. Each communication hole 42 is larger in aperture area, than each intake hole 41. The communication holes 42 are located right under the corresponding one of the recording heads 16.

As shown in FIG. 2 to FIG. 4, the frame body 20 of the transport device 7 includes first to fourth support shafts 69a to 69d (exemplifying the first support member in the disclosure), respectively located at four positions, namely on the left and right sides of the front and rear end portions (exemplifying the plurality of positions in the disclosure). To be more specific, the first support shaft 69a and the fourth support shaft 69d are respectively located at the front and rear end portions of one of the side frames 32, and the second support shaft 69b and the third support shaft 69c are respectively located at the front and rear end portions of the other side frame 32.

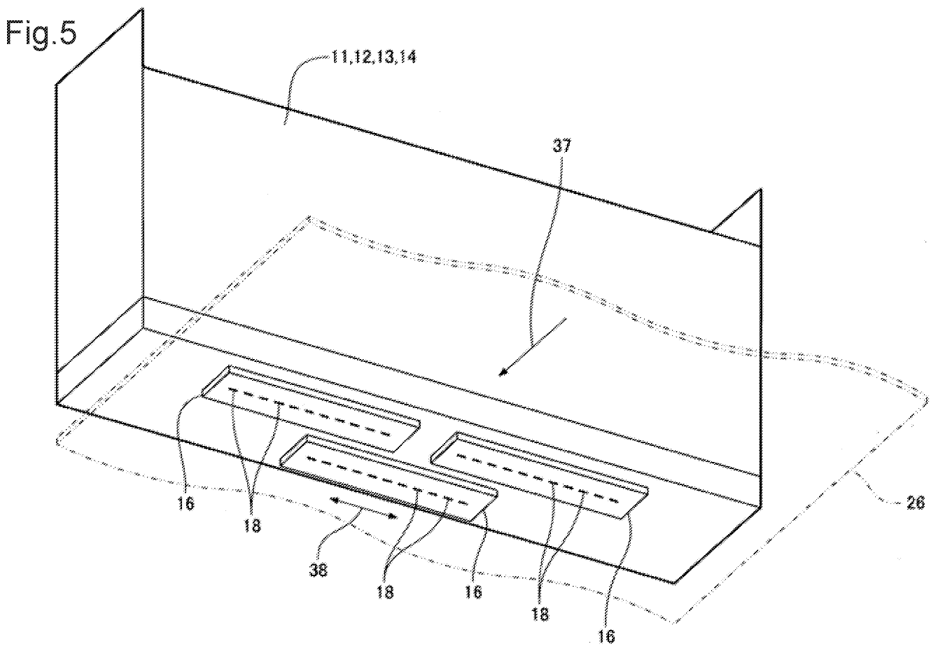

As shown in FIG. 5, a plurality of nozzles 18 (ejection ports), which each eject the ink droplet onto the sheet 2, are arranged in an array in the recording head 16 of each of the head units 11 to 14. Yellow ink is ejected from the nozzle 18 of the head unit 11, magenta ink is ejected from the nozzle 18 of the head unit 12, cyan ink is ejected from the nozzle 18 of the head unit 13, and black ink is ejected from the nozzle 18 of the head unit 14.

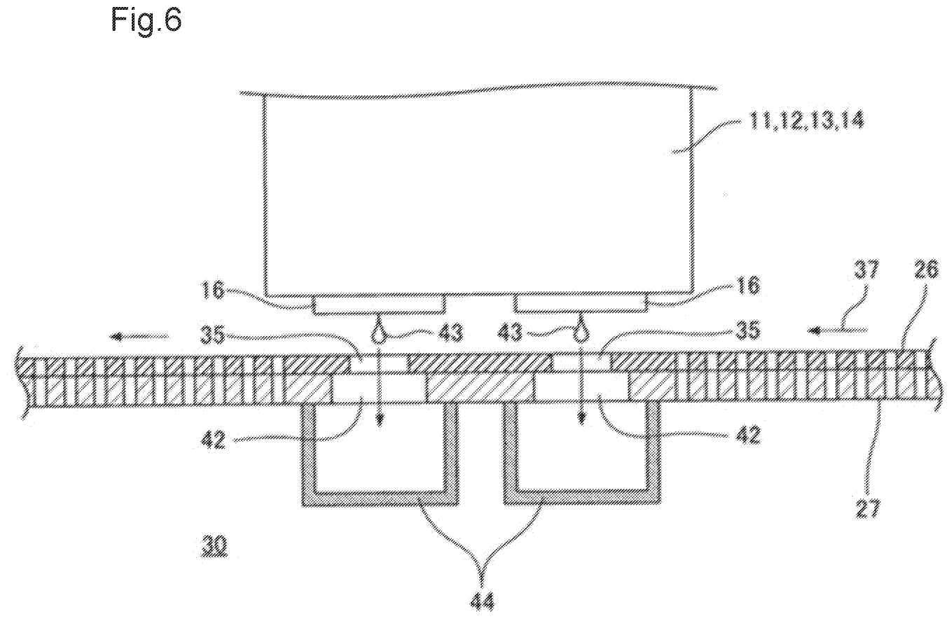

As shown in FIG. 6, a plurality of liquid droplet receptacles 44 are provided inside the suction chamber 30. The liquid droplet receptacles 44 each receive ink droplets 43 (exemplifying the flushing liquid droplet in the disclosure), which has been ejected from the nozzle 18 of the recording head 16 for the flushing operation, and passed through the through hole 35 of the transport belt 26 and the communication hole 42 of the support plate 27, without being involved in the image forming operation.

The sheet 2 delivered from the sheet feeding device 4 to the transport belt 26 in the printing device 3 is transported in the moving direction 37 by the revolving motion of the transport belt 26. In this process, a suction fan 31 rotates thereby depressurizing the suction chamber 30, and outside air flows into the suction chamber 30, through the suction holes 34 and the through holes 35 of the transport belt 26, and the intake holes 41 and the communication holes 42 of the support plate 27. Such airflow adsorbs the sheet 2 to the surface of the transport belt 26.

Accordingly, the sheet 2 is transported in the moving direction 37, without floating from the transport belt 26. In such state, the ink droplets are ejected from the nozzles 18 of the recording heads 16, onto the sheet 2 being transported, so that an image is formed thereon.

The skew detection device 9 detects whether the transport belt 26 is running straightly, or skewing so as to shift in the belt width direction 38. The skew detection device 9 includes a first detector 51, a second detector 52, a plurality of first detection marks 53a to 53n, and a plurality of second detection marks 54a to 54n.

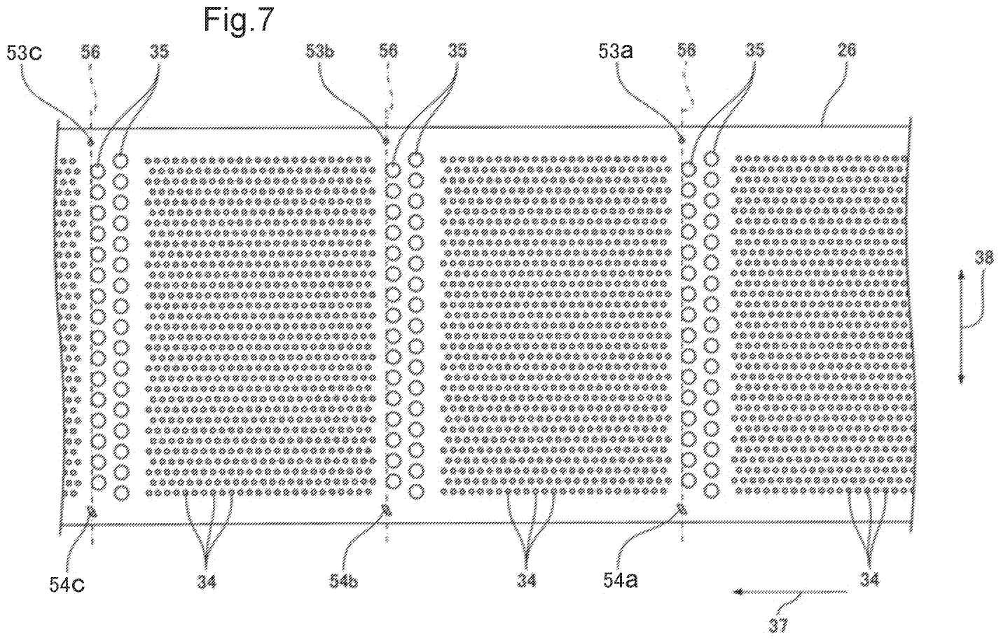

As shown in FIG. 7, the first detection marks 53a to 53n are aligned along an end portion of the transport belt 26 in the belt width direction 38, at predetermined intervals. The first detection marks 53a to 53n each have a circular shape, in a plan view.

The second detection marks 54a to 54n are aligned along the other end portion of the transport belt 26 in the belt width direction 38, at predetermined intervals. In the drawings, only the first detection marks 53a to 53e, and the second detection marks 54a to 54e are illustrated.

The first detection marks 53a to 53n and the second detection marks 54a to 54n are respectively opposed to each other, in the belt width direction 38. In other words, each of the first detection marks 53a to 53n and each of the second detection marks 54a to 54n, opposed to each other in the belt width direction 38, are located on a straight line 56 parallel to the belt width direction 38.

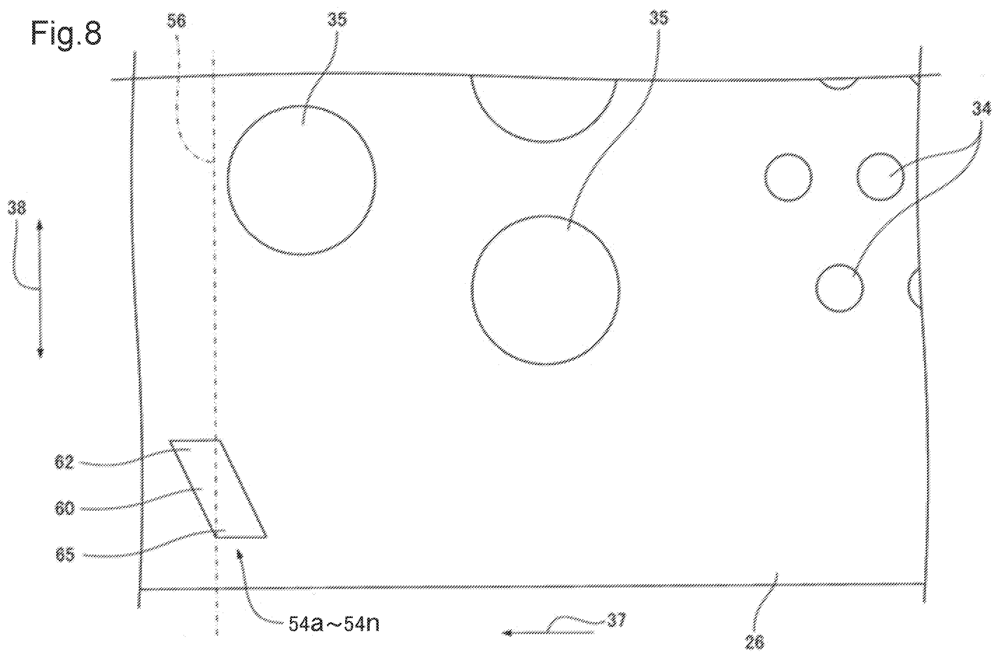

As shown in FIG. 8, the second detection marks 54a to 54n are each formed in a parallelogram in a plan view, inclined in the moving direction 37 of the transport belt 26, with respect to the straight line 56 parallel to the belt width direction 38.

The first detection marks 53a to 53n and the second detection marks 54a to 54n are each formed of a reflective material.

The second detection marks 54a to 54n are each formed such that an end portion in the belt width direction 38, on the leading side in the moving direction 37 of the transport belt 26, is inclined toward the downstream side in the moving direction 37. In addition, the second detection marks 54a to 54n are each formed such that the other end portion in the belt width direction 38, on the trailing side in the moving direction 37, is inclined toward the upstream side in the moving direction 37.

The first detector 51 is a reflective optical sensor that detects the first detection marks 53a to 53n, configured to emit detection light downward, and detect the light reflected by the first detection marks 53a to 53n.

The second detector 52 is a reflective optical sensor that detects the second detection marks 54a to 54n, configured to emit detection light downward, and detect the light reflected by the second detection marks 54a to 54n.

The first detector 51 is located on the upstream side (rear side) in the moving direction 37 of the transport belt 26. The second detector 52 is located on the downstream side (forward side) in the moving direction 37 of the transport belt 26. The first detector 51 and the second detector 52 are distant from each other in the moving direction 37 of the transport belt 26, by a predetermined distance 57.

When the transport belt 26 moves in the moving direction 37 and, for example, the first detection mark 53a reaches the position right under the first detector 51, the detection light emitted downward from the first detector 51 is reflected upward by the first detection mark 53a, so that the first detector 51 detects the reflected light. Thus, the first detection mark 53a is detected. The remaining detection marks 53b to 53n, following the detection mark 53a, are also detected in the same way.

Further, for example when the second detection mark 54a reaches the position right under the second detector 52, the detection light emitted downward from the second detector 52 is reflected upward by the second detection mark 54a, so that the second detector 52 detects the reflected light. Thus, the second detection mark 54a is detected. The remaining detection marks 54b to 54n, following the detection mark 54a, are also detected in the same way.

While the first detection marks 53a to 53n and the second detection marks 54a to 54n are thus detected sequentially, the first detection marks 53a to 53n are each identified, by defining the detection mark 53a as a first mark, and sequentially counting the following detection marks, such as defining the detection mark 53b as a second mark, and the detection mark 53n as an n-th mark.

Likewise, the second detection marks 54a to 54n are each identified, by defining the detection mark 54a as a first mark, and sequentially counting the following detection marks, such as defining the detection mark 54b as a second mark, and the detection mark 54n as an n-th mark.

The skew detection device 9 detects whether the transport belt 26 is running straightly or skewing, on the basis of a detection time. The detection time refers to the elapsed time after the first detector 51 has detected one of the first detection marks 53a to 53n, and until the second detector 52 detects one of the second detection marks 54a to 54n, corresponding to the one of the first detector 53a to 53n that has been detected.

The skew detection device 9 includes a controller. The controller includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The controller executes the operations related to the skew detection of the transport belt 26, and the detection and identification of the detection marks, when the processor operates according to a control program stored, for example, in the ROM. Alternatively, a control device controlling the overall operation of the image forming apparatus 1 may also act as the controller. Such control device also includes, like the controller, a processor, a RAM, a ROM, and an exclusive hardware circuit. Here, whereas the mentioned operations related to the skew detection of the transport belt 26 is executed by the controller, the skew detection device 9 is regarded as the operating component, in the following description.

For example, when the first detector 51 detects the first detection mark 53a as the first one and then the second detector 52 detects, as the first one, the second detection mark 54a corresponding to the first detection mark 53a, the elapsed time after the first detector 51 detected the first detection mark 53a, and until the second detector 52 has detected the second detection mark 54a, is measured, and such measure time is defined as the detection time.

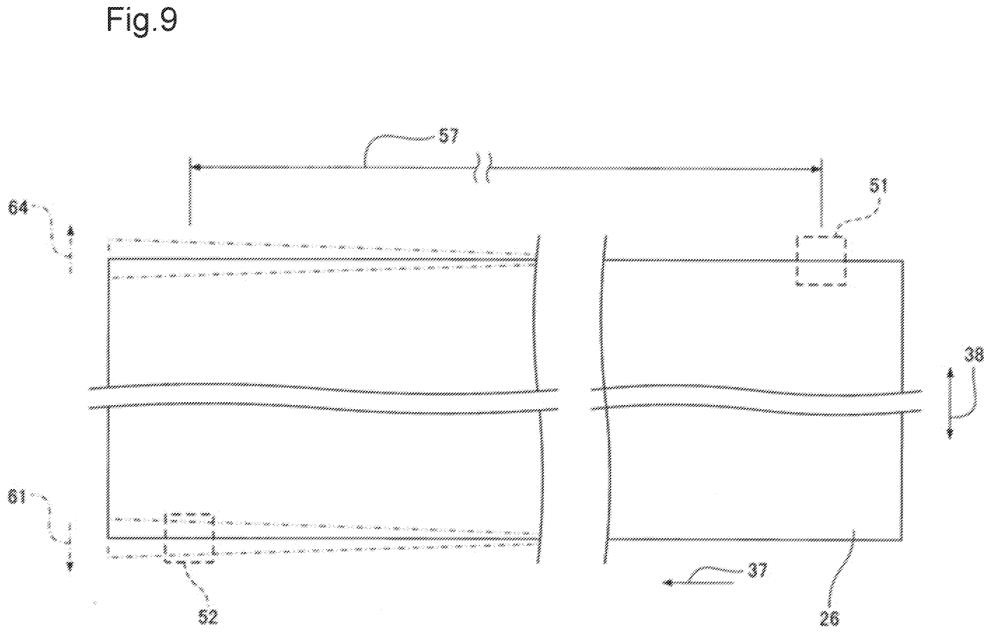

When the transport belt 26 is running straightly as indicated by solid lines in FIG. 9, the second detector 52 detects a central portion 60 of the second detection marks 54a to 54n (see FIG. 8), in the belt width direction 38. When the detection time in this case is defined as T, the detection time T serves as the reference time. The skew detection device 9 stores in advance such detection time, measured when the transport belt 26 is running straightly, as the reference detection time, for example in a built-in non-volatile memory.

When the transport belt 26 is skewing so as to shift to one side 61 in the belt width direction 38, as indicated by dash-dot lines in FIG. 9, the second detector 52 detects an end portion 62 of the second detection marks 54a to 54n (see FIG. 8) in the belt width direction 38. Accordingly, the timing that the second detector 52 detects the second detection marks 54a to 54n becomes slightly earlier, compared with the case where the transport belt 26 is running straightly. Accordingly, when the detection time in this case is defined as T1, the detection time T1, measured when the transport belt 26 is skewing so as to shift to one side 61, becomes slightly shorter than the reference detection time T. Thus, it is detected that the transport belt 26 is skewing so as to shift to one side 61.

On the contrary, when the transport belt 26 is skewing so as to shift to the other side 64 in the belt width direction 38, as indicated by dash-dot-dot lines in FIG. 9, the second detector 52 detects the other end portion 65 of the second detection marks 54a to 54n (see FIG. 8) in the belt width direction 38. Accordingly, the timing that the second detector 52 detects the second detection marks 54a to 54n becomes slightly later, compared with the case where the transport belt 26 is running straightly. Accordingly, when the detection time in this case is defined as T2, the detection time T2, measured when the transport belt 26 is skewing so as to shift to the other side 64, becomes slightly longer than the reference detection time T. Thus, it is detected that the transport belt 26 is skewing so as to shift to the other side 64.

Thus, when the detection time T1 is shorter than the reference detection time T while the transport belt 26 is running, the skew detection device 9 detects that the transport belt 26 is skewing so as to shift to the opposite side of the end portion of the second detection mark 52 in the belt width direction 38 (i.e., one side 61). When the detection time T2 is longer than the reference detection time T, the skew detection device 9 detects that the transport belt 26 is skewing so as to shift to the end portion of the second detection mark 52 in the belt width direction 38 (i.e., the other side 64).

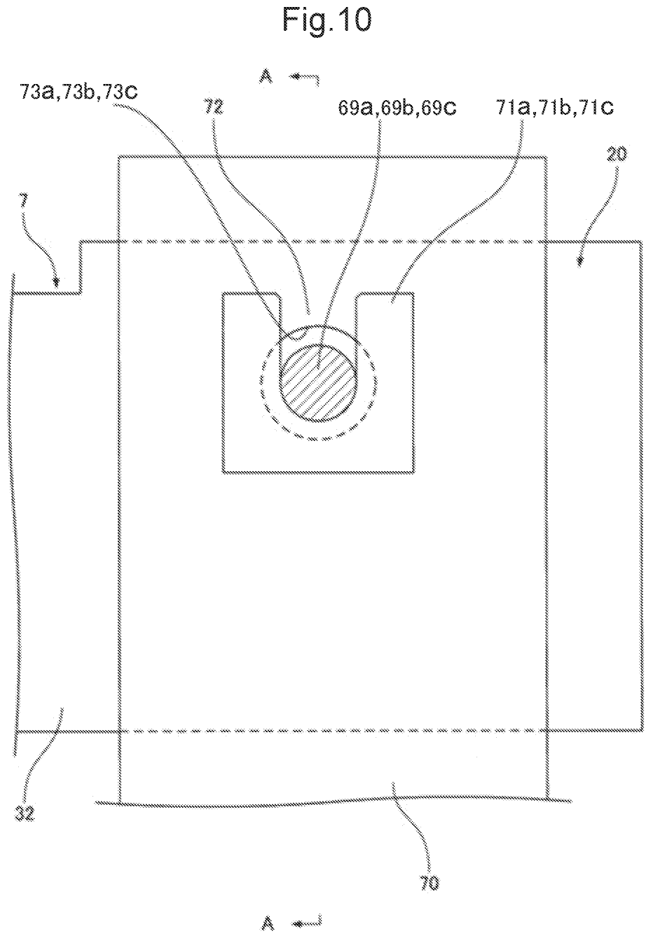

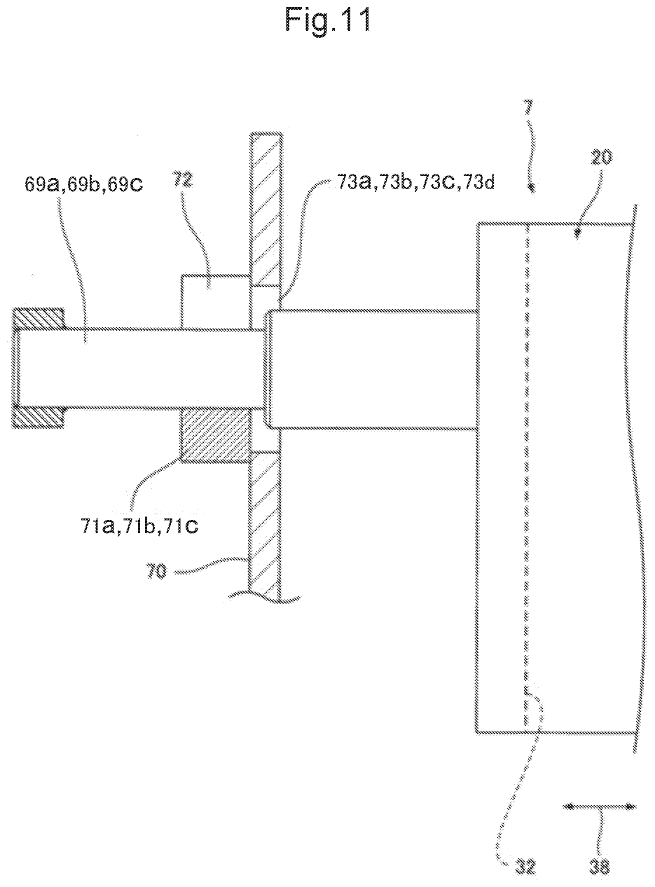

As shown in FIG. 10 and FIG. 11, first to third abutments 71a to 71c, and first to fourth shaft holes 73a to 73d are respectively provided on the fixing frames 70. The first to third abutments 71a to 71c each include a recess 72 having an opening oriented upward.

The first support shaft 69a is inserted in the first shaft hole 73a, and fitted in the recess 72 of the first abutment 71a, thus to be supported by the first abutment 71a. The second support shaft 69b is inserted in the second shaft hole 73b, and fitted in the recess 72 of the second abutment 71b, thus to be supported by the second abutment 71b. The third support shaft 69c is inserted in the third shaft hole 73c, and fitted in the recess 72 of the third abutment 71c, thus to be supported by the third abutment 71c.

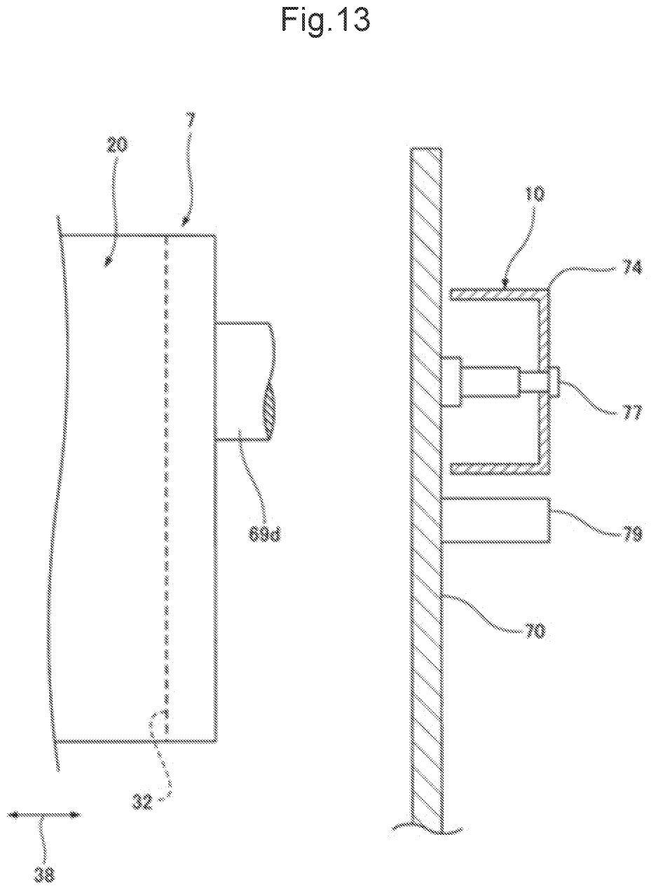

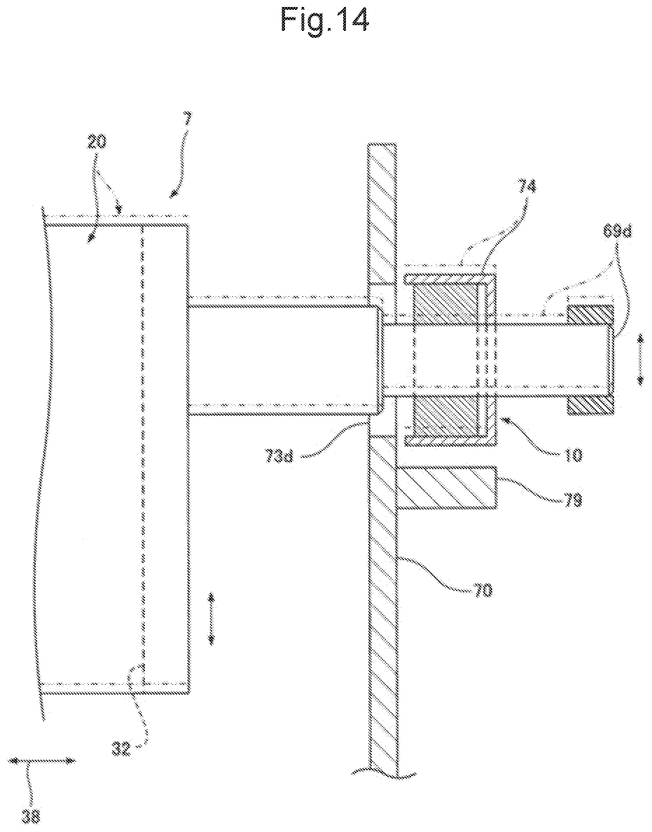

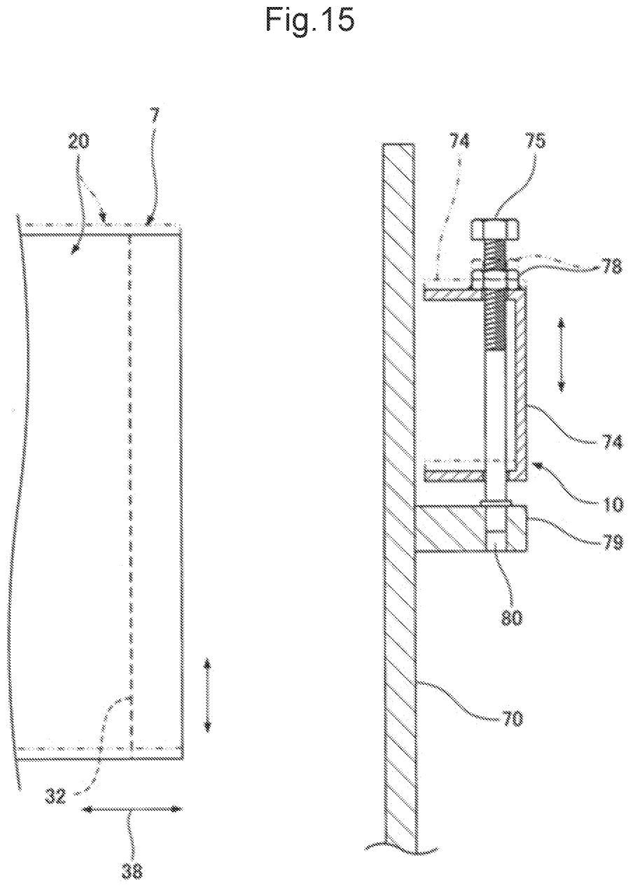

Referring to FIG. 2 and FIG. 12 to FIG. 15, the levelness adjustment device 10 serves to adjust the levelness of the transport device 7. The levelness adjustment device 10 includes a support block 74 (exemplifying the second support member in the disclosure) supporting the fourth support shaft 69d, and configured to move (swing) in the up-down direction, and an adjustment screw 75 (exemplifying the moving member in the disclosure) that moves the support block 74 in the up-down direction.

The support block 74 is supported by a mounting shaft 77 fixed to the fixing frame 70, so as to swing in the up-down direction about the mounting shaft 77 as the fulcrum. The fourth support shaft 69d is inserted in the fourth shaft hole 73d of the fixing frame 70, and penetrating through the support block 74 in the belt width direction 38.

A nut 78 is attached to the upper face of the free end portion of the support block 74. The adjustment screw 75 is screw-fitted with the nut 78 so as to penetrate through the free end portion of the support block 74 in the up-down direction, and rotatably retained by a retention plate 79 provided under the support block 74.

The retention plate 79 is attached to the fixing frame 70. The retention plate 79 includes a retention hole 80, to which the lower end portion of the adjustment screw 75 is inserted from the upper side.

The transport device 7 is supported by the first to third abutments 71a to 71c and the support block 74 of the levelness adjustment device 10, via the first to fourth support shafts 69a to 69d.

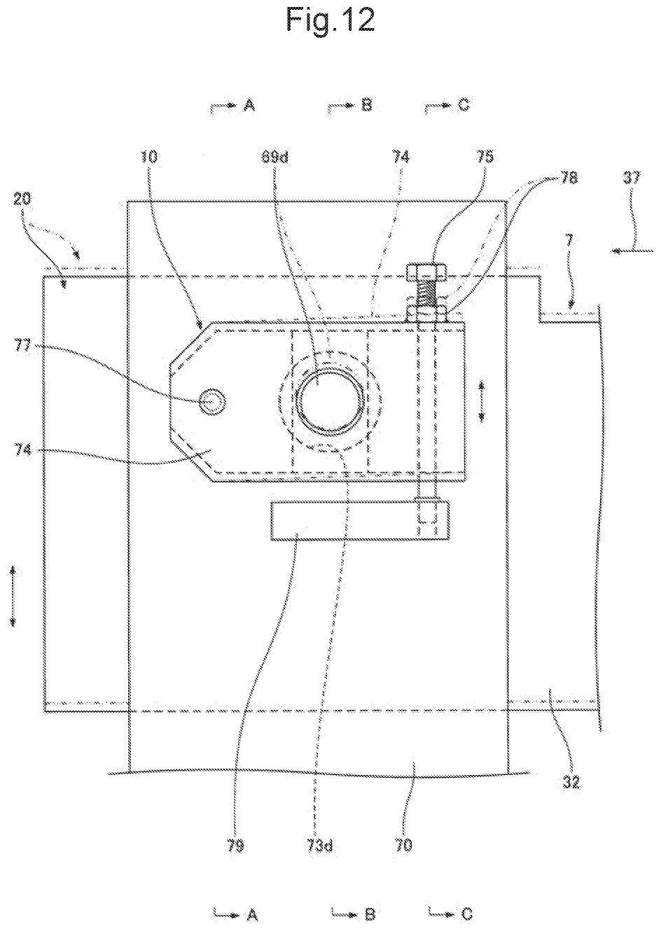

When the adjustment screw 75 is rotated in one direction, the nut 78 is lifted upward as indicated by imaginary lines in FIG. 12, and the support block 74 swings upward about the mounting shaft 77, thereby lifting up the fourth support shaft 69d.

On the contrary, when the adjustment screw 75 is rotated in the opposite direction, the nut 78 is moved downward, and the support block 74 swings downward about the mounting shaft 77, thereby moving the fourth support shaft 69d downward. Thus, the levelness of the transport device 7 can be adjusted, by moving the fourth support shaft 69d upward or downward.

In the image forming apparatus 1 configured as above, when the transport belt 26 is running straightly as indicated by the solid lines in FIG. 9, for example the time after the first detector 51 detected the first detection mark 53a, and until the second detector 52 detects the second detection mark 54a, corresponds to the reference detection time T. Therefore, it can be detected that the transport belt 26 is running straightly.

Referring to FIG. 6, when the flushing operation is performed, the ink droplet 43 is ejected from the nozzle 18 of the recording head 16, at the timing that the through hole 35 of the transport belt 26, running in the moving direction 37 without carrying thereon the sheet 2, passes the position right under the nozzle 18. Accordingly, the ink droplet 43 passes through the through hole 35 of the transport belt 26, and the communication hole 42 of the support plate 27, thus to be received by the liquid droplet receptacle 44.

Periodically performing such flushing operation contributes to preventing the clogging of the nozzle 18, arising from drying of the ink.

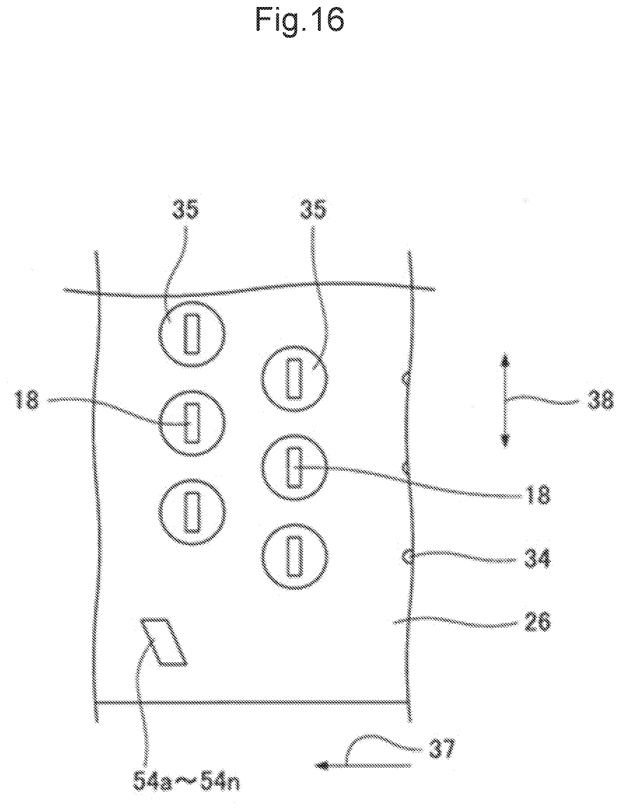

When the flushing operation is performed in the state where the transport belt 26 is running straightly as indicated by the solid lines in FIG. 9, the through hole 35 of the transport belt 26 is located right under the nozzle 18 as shown in FIG. 16. Therefore, the ink droplet 43 ejected from the nozzle 18 can be prevented from sticking to the surface of the transport belt 26.

When the transport belt 26 is skewing so as to shift to one side 61, as indicated by the dash-dot lines in FIG. 9, for example the time after the first detector 51 detected the first detection mark 53a, and until the second detector 52 detects the second detection mark 54a (detection time T1), becomes slightly shorter than the reference detection time T. Therefore, it can be detected that the transport belt 26 is skewing so as to shift to one side 61.

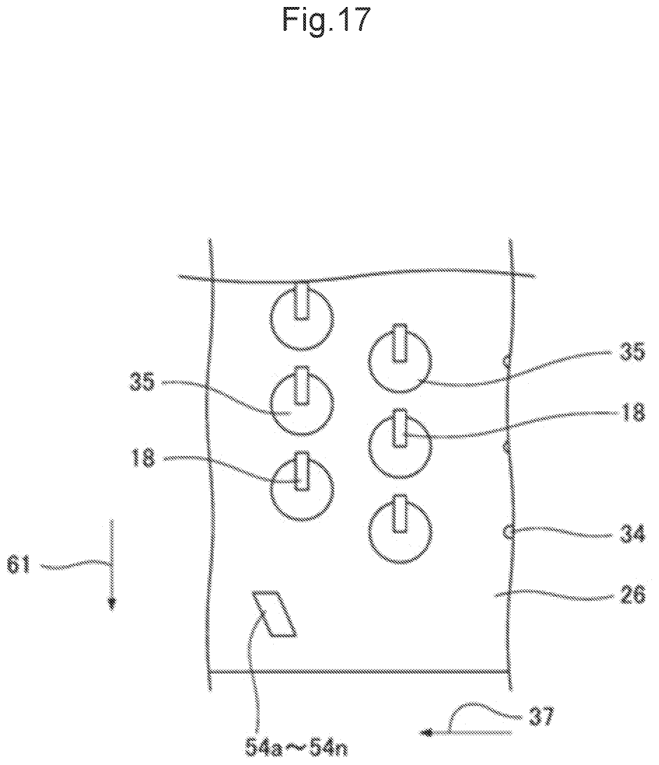

When the flushing operation is performed in the state where the transport belt 26 is skewing so as to shift to one side 61, as indicated by the dash-dot lines in FIG. 9, the position of the through hole 35 of the transport belt 26 is shifted to one side 61 from the position right under the nozzle 18 as shown in FIG. 17. Therefore, the ink droplet 43 ejected from the nozzle 18 may stick to the surface of the transport belt 26.

Further, when the transport belt 26 is skewing so as to shift to the other side 64, as indicated by the dash-dot-dot lines in FIG. 9, for example the time after the first detector 51 detected the first detection mark 53a, and until the second detector 52 detects the second detection mark 54a (detection time T2), becomes slightly longer than the reference detection time T. Therefore, it can be detected that the transport belt 26 is skewing so as to shift to the other side 64.

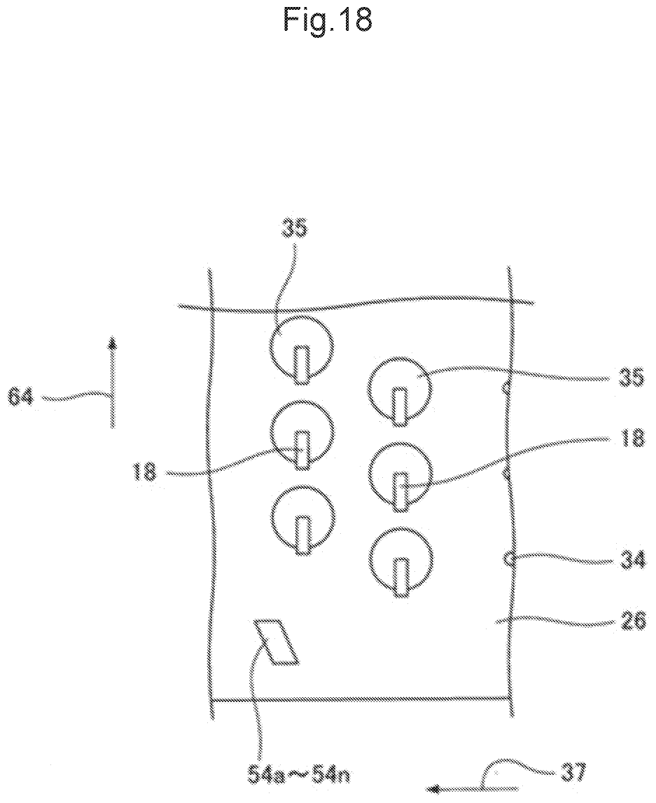

When the flushing operation is performed in the state where the transport belt 26 is skewing so as to shift to the other side 64, as indicated by the dash-dot-dot lines in FIG. 9, the position of the through hole 35 of the transport belt 26 is shifted to the other side 64 from the position right under the nozzle 18 as shown in FIG. 18. Therefore, the ink droplet 43 ejected from the nozzle 18 may stick to the surface of the transport belt 26.

When the skewing of the transport belt 26 is detected as above, it is preferable to rotate the adjustment screw 75 of the levelness adjustment device 10, to thereby adjust the levelness of the transport device 7. For example, when the transport device 7 is tilted to one side 61, and the fourth support shaft 69d is located at a lower position than the remaining support shafts 69a to 69c, the transport belt 26 may skew so as to shift to one side 61, as indicated by the dash-dot lines in FIG. 9. In this case, by rotating the adjustment screw 75 in one direction, the nut 78 is lifted upward as indicated by the imaginary lines in FIG. 12, and the support block 74 swings upward about the mounting shaft 77, thereby lifting the fourth support shaft 69d upward. Thus, the fourth support shaft 69d can be brought to the same height as the remaining support shafts 69a to 69c, so that the transport device 7 can recover the horizontal posture. By allowing thus the transport device 7 to recover the horizontal posture, the skewing of the transport belt 26 can be corrected to the straight state. As result, the transport belt 26 runs straightly without skewing, when made to move in the moving direction 37.

Likewise, when the transport device 7 is tilted to the other side 64, and the fourth support shaft 69d is located at a higher position than the remaining support shafts 69a to 69c, the transport belt 26 may skew so as to shift to the other side 64, as indicated by the dash-dot-dot lines in FIG. 9. In this case, by rotating the adjustment screw 75 in the opposite direction, the nut 78 is moved downward, and the support block 74 swings downward about the mounting shaft 77, thereby moving the fourth support shaft 69d downward. Thus, the fourth support shaft 69d can be brought to the same height as the remaining support shafts 69a to 69c, so that the transport device 7 can recover the horizontal posture. By allowing thus the transport device 7 to recover the horizontal posture, the skewing of the transport belt 26 can be corrected to the straight state. As result, the transport belt 26 runs straightly without skewing, when made to move in the moving direction 37.

As described above, when transport belt 26 is skewing, the transport belt 26 can be quickly corrected so as to run straightly, by adjusting the levelness of the transport device 7. In addition, by allowing the transport belt to run straightly, the through hole 35 of the transport belt 26 is located right under the nozzle 18 when the flushing operation is performed. Therefore, the ink droplet 43 ejected from the nozzle 18 can be prevented from sticking to the surface of the transport belt 26.

In the case of the existing image forming apparatus, when the transport belt is skewing so as to shift in the belt width direction, the suction hole of the transport belt is shifted in the belt width direction, with respect to the nozzle. Accordingly, in the flushing operation, the ink droplet spitted from the nozzle may fail to pass through the suction hole of the transport belt, and fall onto the surface of the transport belt. To prevent such failure, some measures have to be quickly taken to enable the transport belt to run straightly, which, however, has thus far been difficult.

In contrast, with the configuration according to the foregoing embodiment, the transport belt 26 can be quickly corrected so as to run straightly, when the skewing of the transport belt 26 is detected.

According to Embodiment 1, the fourth support shaft 69d is made to move upward or downward, with the levelness adjustment device 10 as shown in FIG. 2, to adjust the levelness of the transport device 7. Instead, one of the first to third support shafts 69a to 69c may be made to move upward or downward, with the levelness adjustment device 10.

Alternatively, a plurality of levelness adjustment devices 10 may be provided, to move the respectively corresponding ones of the first to fourth support shafts 69a to 69d, upward or downward. Further, four levelness adjustment devices 10 may be provided, to move all the support shafts 69a to 69d upward or downward.

The embodiment of the disclosure has been described as above, with reference to the drawings. However, the disclosure is not limited to the foregoing embodiment, but may be modified in various manners, without departing from the scope of the disclosure. The drawings each schematically illustrate the elements for the sake of clarity, and the thickness, length, number of pieces, and interval of the illustrated elements may be different from the actual ones, because of the convenience in making up the drawings. Further, the material, shape, and size of the elements referred to in the foregoing embodiment are merely exemplary and not specifically limited, and may be modified as desired, without substantially departing from the configuration according to the disclosure.

### INDUSTRIAL APPLICABILITY

The disclosure provides the image forming apparatus, and is therefore industrially applicable.

What is claimed is:

1. An image forming apparatus comprising:
a recording head including a plurality of nozzles that each eject a liquid droplet to a recording medium, the nozzles being arranged in an array;
a transport device including an endless belt that transports the recording medium toward an image forming position where the recording head forms an image;
a plurality of through holes formed in the endless belt, to be used for a flushing operation;
a liquid droplet receptacle that receives a flushing liquid droplet, which has been ejected from the nozzle and passed through the through hole, without being involved in image forming;
a skew detection device that detects whether the endless belt is running straightly or skewing so as to shift in a belt width direction; and
a levelness adjustment device that adjusts levelness of the transport device.

2. The image forming apparatus according to claim 1,
wherein the skew detection device includes:
a first detection mark located on one end portion of the endless belt in the belt width direction;
a second detection mark located on the other end portion of the endless belt in the belt width direction;
a first detector that detects the first detection mark; and
a second detector that detects the second detection mark,
the first detection mark and the second detection mark are located so as to oppose each other in the belt width direction,
the first detector and the second detector are spaced from each other by a predetermined distance, in a moving direction of the endless belt, and
one of the first detection mark and the second detection mark is inclined in the moving direction of the endless belt, with respect to a straight line parallel to the belt width direction.

3. The image forming apparatus according to claim 2,
wherein the second detection mark is inclined, and
the skew detection device detects whether the endless belt is running straightly or skewing so as to shift in the belt width direction, on a basis of an elapsed time after the first detector detected the first detection mark, and until the second detector detects the second detection mark.

4. The image forming apparatus according to claim 3,
wherein the second detection mark is formed such that:
one end portion in the belt width direction, on a leading side in the moving direction, is inclined toward a downstream side in the moving direction; and
the other end portion in the belt width direction, on an opposite side of the one end portion, on a trailing side in the moving direction, is inclined toward an upstream side in the moving direction,
the skew detection device is configured to:
store in advance the elapsed time measured when the endless belt is running straightly, as a reference detection time; and
detect, when the endless belt is running, that the endless belt is skewing so as to shift in the belt width direction, to the opposite side of the one end portion of the second detection mark, when the elapsed time is shorter than the reference detection time, and that the endless belt is skewing so as to shift in the belt width direction, to the side of the one end portion of the second detection mark, when the elapsed time is longer than the reference detection time.

5. The image forming apparatus according to claim 1,
wherein a first support member is provided at each of a plurality of positions in the transport device, and
the levelness adjustment device includes:
a second support member supporting at least one of the first support members, and configured to move in an up-down direction; and
a moving member that moves the second support member in the up-down direction.
